(19) United States
(12) Patent Application Publication
(10) Pub. No.: US 2023/0145455 A1
(43) Pub. Date: May 11, 2023

(54) COLLISION AVOIDANCE SYSTEM AND VEHICLE EQUIPPED WITH IT

(71) Applicant: RENESAS ELECTRONICS CORPORATION, Tokyo (JP)

(72) Inventor: Suguru FUJITA, Tokyo (JP)

(21) Appl. No.: 17/948,769

(22) Filed: Sep. 20, 2022

(30) Foreign Application Priority Data
Nov. 5, 2021 (JP) 2021-181107

(51) Int. Cl. B60W 50/14; B60W 30/095; B60W 40/04; H04W 4/46

(52) U.S. Cl. CPC B60W 50/14; B60W 30/0956; B60W 40/04; H04W 4/46; B60W 2420/42; B60W 2420/52; B60W 2554/4046; B60W 2556/60; B60W 2556/65

(57) ABSTRACT

A collision-avoidance system includes a sensor, a surrounding monitoring system that outputs monitoring detection information based on information acquired by the sensor, an surrounding area information acquisition system that outputs surrounding area information related to a current location, and an assistance system that generates assistance information for controlling the surrounding monitoring system based on the surrounding area information and outputs the generated assistance information to the surrounding monitoring system.

### CROSS-REFERENCE TO RELATED APPLICATIONS

The disclosure of Japanese Patent Application No. 2021-181107 filed on Nov. 5, 2021, including the specification, drawings and abstract is incorporated herein by reference in its entirety.

### BACKGROUND

The present invention relates to a collision avoidance system and a vehicle on which it is mounted, for example, to a collision avoidance system having a surrounding monitoring system for monitoring the surrounding area of the vehicle using a sensor and detecting the approaching vehicle, and a vehicle on which it is mounted.

For example, Japanese Unexamined Patent Application No. 2012-226635 (Patent Document 1) discloses a technique for preventing a vehicle collision. Patent Document 1 discloses describes a safety device for collision avoidance capable of contributing to low power consumption without degradation of the collision avoidance function.

### SUMMARY

The surrounding monitoring system uses, for example, a camera or a radar using radio waves as a sensor to receive an image or reflected radio waves of a vehicle approaching an own vehicle. The surrounding monitoring system detects the presence of a vehicle approaching or the distance between the vehicle and the own vehicle, and notifies the driver of the own vehicle. However, the detection accuracy of the surrounding monitoring system depends on the environment around the own vehicle. Therefore, in a specific surrounding environment, the detection accuracy of the surrounding monitoring system may deteriorate, and it may become difficult to smoothly perform collision avoidance. For example, in an environment where there is a building between the own vehicle and the approaching vehicle, radio waves are weakened by the building, and the detection accuracy of detecting the approaching vehicle may deteriorate. Also, even in environment where sunlight or streetlight enters into the camera, the detection accuracy of the surrounding monitoring system may deteriorate.

Incidentally, the collision avoidance system may include a system having an approaching vehicle notification system in addition to the surrounding monitoring system. The approaching vehicle notification system performs wireless communication (inter-vehicle communication) between the own vehicle and other vehicles, to inform each other's position. The approaching vehicle notification system calculates the distance between the own vehicle and the approaching vehicle based on the obtained location information, and notifies the driver of the own vehicle of information of the approaching vehicle. By providing the approaching vehicle notification system, the own vehicle can detect the vehicle that is outside the detection range of the sensor with the inter-vehicle communication and notify the driver of the own vehicle. However, in certain surrounding environments, inter-vehicle communication may be difficult. In such an area, for example, it may become difficult to detect a vehicle moving from outside the detection range of the sensor into the detection range within a time required for collision avoidance. Thus, it may be difficult to perform the collision avoidance smoothly.

Patent Document 1 neither describes nor suggests such a problem. Other objects and novel features will become apparent from the description of this specification and the accompanying drawings.

The typical ones of the embodiments disclosed in the disclosure will be briefly described as follows.

According to one aspect of the present invention, a collision-avoidance system includes a sensor, a surrounding monitoring system that outputs monitoring detection information based on information acquired by the sensor, an surrounding area information acquisition system that outputs surrounding area information related to a current location, and an assistance system that generates assistance information for controlling the surrounding monitoring system based on the surrounding area information and outputs the generated assistance information to the surrounding monitoring system.

According to the present embodiments, it is possible to provide a collision avoidance system capable of improving the detection accuracy of vehicles requiring collision avoidance.

### BRIEF DESCRIPTION OF THE DRAWINGS

FIG. 1 is a block diagram showing a configuration of a collision avoidance system according to the first embodiment.

FIG. 2 is a diagram for explaining an operation example of the collision avoidance system according to the first embodiment.

FIG. 3 is a schematic diagram for explaining an operation example of the collision avoidance system according to the first embodiment.

FIG. 4 is a schematic diagram for explaining an operation example of the collision avoidance system according to the first embodiment.

FIG. 5 is a diagram for explaining an operation example of the collision avoidance system according to the first embodiment.

FIG. 6 is a diagram for explaining an operation example of the collision avoidance system according to the first embodiment.

FIG. 7 is a diagram for explaining an operation example of the collision avoidance system according to the first embodiment.

FIG. 8 is a circuit diagram showing a configuration of a range control circuit according to the first embodiment.

FIG. 9 is a diagram for explaining a problem to be solved in the second embodiment.

FIG. 10 is a diagram for explaining a problem to be solved in the second embodiment.

FIG. 11 is a block diagram showing a configuration of a collision avoidance system according to the second embodiment.

FIG. 12 is a diagram for explaining a first operation example of the collision avoidance system according to the second embodiment.

FIG. 13 is a diagram for explaining the first operation example of the collision avoidance system according to the second embodiment.

FIG. 14 is a diagram for explaining a second operation example of the collision avoidance system according to the second embodiment.

FIG. 15 is a diagram for explaining the second operation example of the collision avoidance system according to the second embodiment.

FIG. 16 is a diagram for explaining the second operation example of the collision avoidance system according to the second embodiment.

FIG. 17 is a diagram for explaining the second operation example of the collision avoidance system according to the second embodiment.

FIG. 18 is a diagram for explaining the second operation example of the collision avoidance system according to the second embodiment.

FIG. 19 is a block diagram showing a configuration of a collision avoidance system according to the third embodiment.

FIG. 20 is a diagram for explaining the collision avoidance system according to the third embodiment.

FIG. 21 is a diagram for explaining the collision avoidance system according to the third embodiment.

FIG. 22 is a schematic diagram showing a vehicle having the collision avoidance system of the present embodiments.

### DETAILED DESCRIPTION

Hereinafter, embodiments of the present invention are described in detail with reference to the drawings. It is to be noted that the disclosure is merely an example, and those skilled in the art can easily conceive of appropriate changes while maintaining the gist of the invention are naturally included in the scope of the invention.

In this specification and each drawing, the same or corresponding components are denoted by the same reference numerals, and a repetitive description thereof may be omitted.

### First Embodiment

In the following description, a collision avoidance system mounted on a vehicle is described as an example, but the present invention is not limited thereto. FIG. 22 is a schematic diagram showing a vehicle having the collision avoidance system according to the first embodiment. FIG. 22 shows a vehicle 100. An automobile is described as an example of the vehicle, but the present invention is not limited thereto. The vehicle 100 also includes a collision avoidance system 1. The collision avoidance system 1 detects a vehicle approaching the vehicle 100 and notifies the driver (not shown) of the vehicle 100 of the detected vehicle information. The notified driver operates, for example, the vehicle 100 to avoid a collision with the notified vehicle. Here, an example will be described in which the collision avoidance system 1 notifies the driver of an approaching vehicle, but the present invention is not limited thereto. For example, the vehicle 100 may be configured to operate to automatically avoid a collision based on the notification of the collision avoidance system 1.

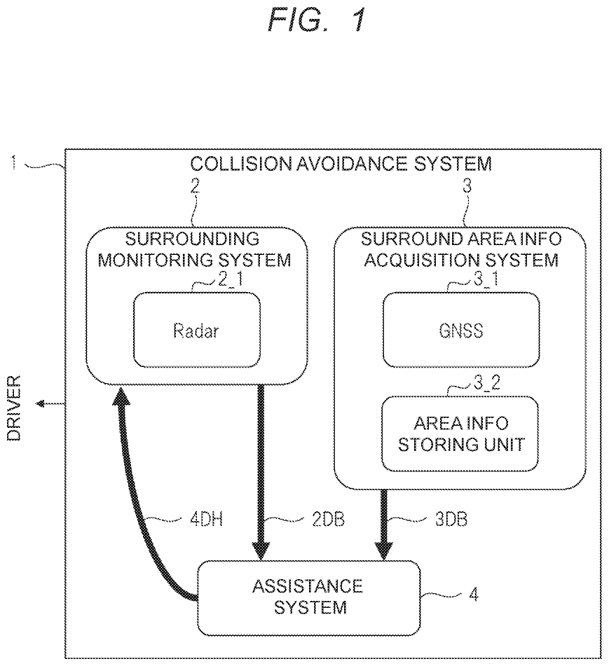

FIG. 1 is a block diagram showing a configuration of a collision avoidance system according to the first embodiment. In FIG. 1, a block diagram of a collision avoidance system 1 is shown. The collision avoidance system 1 includes various systems, but only what is required in the following description is depicted in FIG. 1.

The collision avoidance system 1 of FIG. 1 includes a surrounding monitoring system 2, a surrounding area information acquisition system 3, and an assistance system 4. The surrounding monitoring system 2 includes a sensor. The surrounding monitoring system 2 detects the vehicle present in the detection range of the sensor based on the sensor information detected by the sensor (signal or data), and outputs information about the detected vehicle as a monitoring detection information 2DB. In FIG. 1, a radar 2_1 is illustrated as sensor. The radar 2_1 transmits radio waves and receives radio waves reflected by an approaching vehicle (object). The object detection processing, which is a signal processing, is performed based on the radio waves (receiving signals) received by the radar 2_1, so that information about the direction or distance to the object is acquired. The area in which the reflected radio waves can be received becomes the detection range of the radar 2_1. Instead of the radar 2_1, for example, a camera or the like may be used as a sensor. In the case, the area that can be captured by the camera is the detection range of the camera. Then, image processing is performed on the image captured by the camera, so that information on the direction or distance to the object is acquired.

The surrounding area information acquisition system 3 identifies the location of the vehicle (own vehicle) 100 having the collision avoidance system 1, which is current location of the own vehicle. The surrounding area information acquisition system 3 outputs information of surrounding area associated with the identified location as a surrounding area information 3DB. The surrounding area information acquisition system 3 according to the first embodiment includes a device using Global Navigation Satellite System (hereinafter, also referred to as GNSS) 3_1 and an area information storing unit 3_2 for storing information of a surrounding area of the location identified by the GNSS 3_1.

The monitoring detection information 2DB and the surrounding area information 3DB are transferred to the assistance system 4. The assistance system 4 generates assistance information 4DH for assisting detection operations of the surrounding monitoring system 2 based on the monitoring detection information 2DB and the surrounding area information 3DB. The generated assistance information 4DH is supplied to the surrounding monitoring system 2. The assistance information 4DH may be referred to as first assistance information 4DH. The detection operations of the surroundings monitoring systems 2 are controlled by the assistance information 4DH. In FIG. 1, the assistance system 4 generates the assistance information 4DH based on the monitoring detection information 2DB and the surrounding area information 3DB. However, the information for generating the assistance information is not limited to the monitoring detection information 2DB and the surrounding area information 3DB. For example, the assistance system 4 may generate the assistance information 4DH based on the surrounding area information 3DB without using the monitoring detection information 2DB. In the first embodiment, the assistance system 4 assists the surrounding monitoring system 2. The assistance system 4 can be regarded as an assistance system for the surrounding monitoring system 2.

In the collision avoidance system 1 according to the first embodiment, the surrounding monitoring system 2 is controlled by the assistance information 4DH based on the surrounding area information 3DB which is the information of the surrounding area obtained by the surrounding area information acquisition system 3. That is, the surrounding monitoring system 2 is controlled in accordance with a surrounding area specific situation obtained by the surrounding area information acquisition system 3. As a result, the surrounding monitoring system 2, in accordance with the surrounding area specific situation, is possible to improve the detection accuracy of the vehicle present within the detection range of the sensor. Therefore, it becomes possible to detect vehicles requiring collision avoidance in a short time, it becomes possible to smoothly perform the actions for collision avoidance.

### <Operation of the Collision Avoidance System>

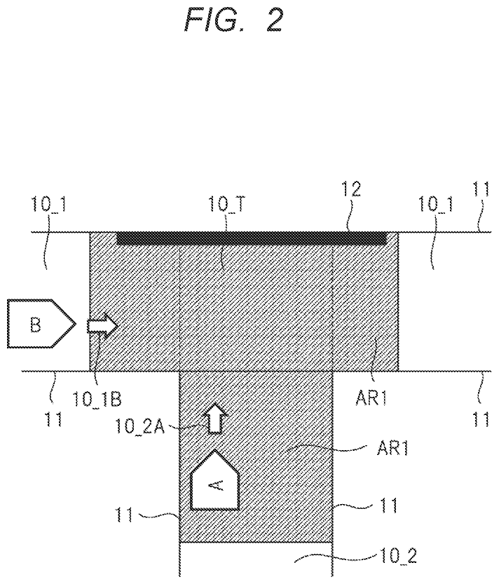

Next, an operation example of the collision avoidance system 1 will be described with reference to the drawings. FIGS. 2 to 7 are diagrams for explaining an operation example of the collision avoidance system 1 according to the first embodiment. Here, as an example, a case will be described in which a relatively large metal fence is installed at a so-called T-shaped intersection, and the radar 2_1 in the collision avoidance system 1 is affected by the metal fence.

In FIG. 2, roads 10_1 and 10_2 are indicated. A straight-ahead road 10_1 and a straight-ahead road 10_2 intersect at a T-shaped intersection 10_T. At the intersection 10_T, a relatively large metal fence 12 is installed in the traveling direction of the road 10_2.

In FIG. 2, the own vehicle is indicated as reference numeral A. The own vehicle A is driven on the road 10_2 in the direction indicated by the direction 10_2A toward the intersection 10_T. The reference numeral B denotes a vehicle approaching the own vehicle A. The vehicle B is driven on the road 10_1 in the direction indicated by the direction 10_1B toward the intersection 10_T. The own vehicle A includes the collision avoidance system 1 described above. The collision avoidance system 1 detects the presence of the vehicle B so as to avoid a collision with the vehicle B and notifies the driver of the own vehicle A.

In FIG. 2, walls 11 are installed along roads 10_1 and 10_2. It is difficult for the driver of the own vehicle A to see the vehicle B because of the walls 11. Furthermore, the presence of the vehicle B is not detected by the surrounding monitoring system 2, because the radio wave of the radar 2_1 in the collision avoidance system 1 is blocked by the walls 11 and does not reach the vehicle B. That is, the vehicle B is to be present outside the detection range of the sensors in the collision avoidance system 1 of the own vehicle A.

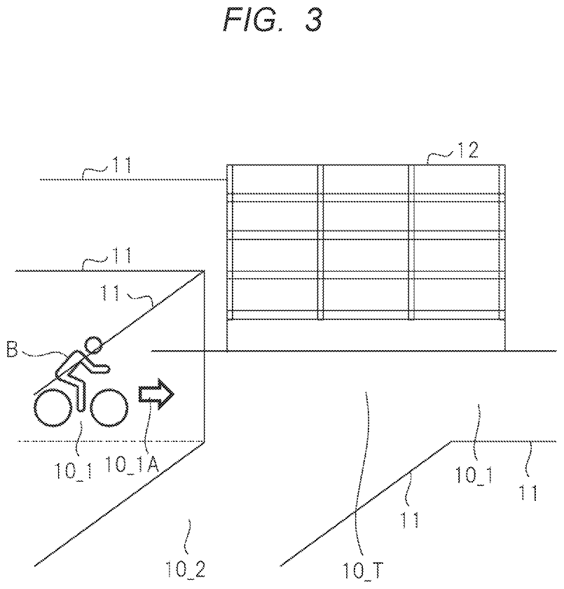

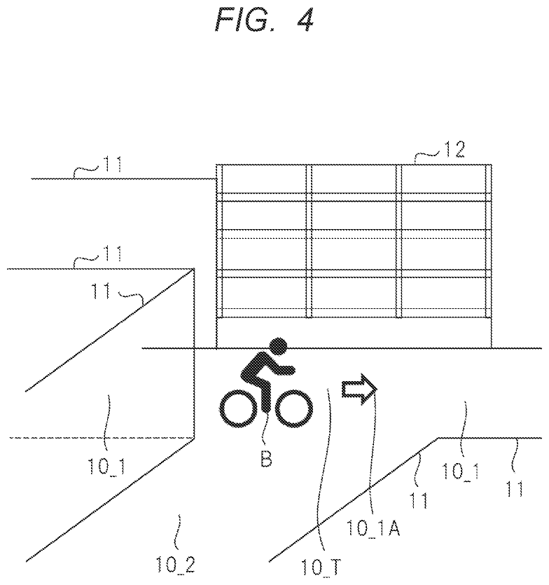

FIGS. 3 and 4 are schematic diagrams showing FIG. 2 three-dimensionally, taking the case where the vehicle B of FIG. 2 is a bicycle as an example. In FIGS. 3 and 4, a part of the walls 11 and the own vehicle A are omitted. In the following description, the bicycle will also be described using the reference symbol B.

As shown in FIG. 3, the bicycle B moves toward the intersection 10_T. As shown in FIG. 4, The bicycle B passes in front of the metal fence 12 installed facing the road 10_2, that is, between the metal fence 12 and the road 10_2. In other words, the bicycle B moves from outside the detection range of the sensors in the surrounding monitoring system 2 in the collision avoidance system 1 of the own vehicle A within the detection range.

The radar 2_1 in the surrounding monitoring system 2 in the collision avoidance system 1 mounted on the own vehicle A receives a reflected wave from an object such as a vehicle existing within the detection range of the radar 2_1. The radar 2_1 has a dynamic range DRG that indicates a range within which signal processing of the received signal can be performed.

Therefore, the radar 2_1 can detect an object if a reflected wave from the object is within a range between the minimum level (min) and the maximum level (max) of the dynamic range DRG.

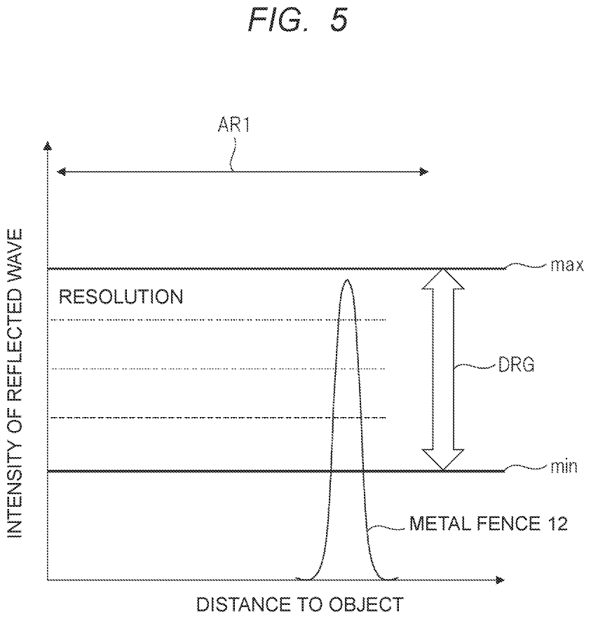

The surrounding monitoring system 2 outputs the distance to the object detected by the radar 2_1 as the monitoring detection information 2DB. The surrounding monitoring system 2 typically dynamically changes the dynamic range DRG of radar 2_1 over time in order to detect objects generating reflected waves of various intensities. That is, the surrounding monitoring system 2, while maintaining the range width between the minimum level (min) and the maximum level (max), moves the dynamic range DRG shown in FIG. 5, for example, up and down periodically.

As shown in FIGS. 2 and 3, a relatively large metal fence 12 is installed at the intersection 10_T. That is, there is an object having a large radar reflection cross-section area in the front side of the radar 2_1. In this case, the surrounding monitoring system 2 typically controls the dynamic range DRG to maintain a status capable of detecting the reflected wave from the metal fence 12 for detecting the metal fence 12 having a large radar reflection cross-section area.

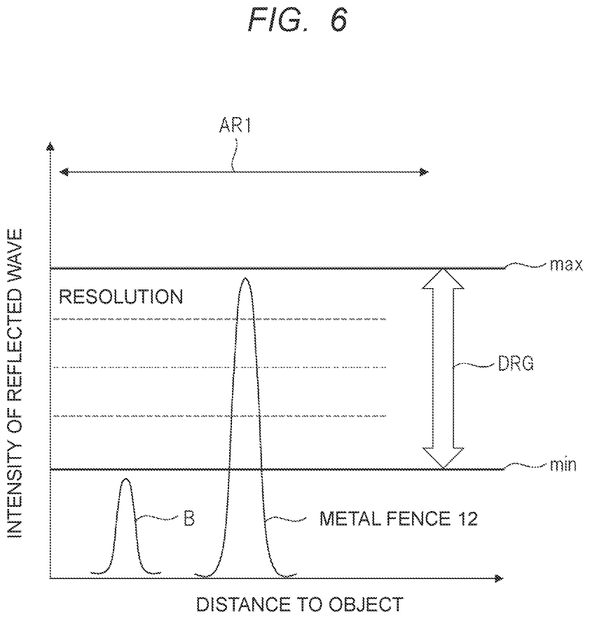

The intensity of the reflected wave of the bicycle B is smaller than that of the metal fence 12. Therefore, as shown in FIG. 6, the reflected wave from the bicycle B may fall outside the dynamic range DRG set to detect the reflected wave from the metal fence 12. In this case, as shown in FIG. 4, even if the bicycle B moves within the detection range of the radar 2_1, the bicycle may not be detected by the surrounding monitoring system 2. Therefore, it may be difficult to smoothly avoid the collision.

In the collision avoidance system 1 according to the first embodiment, the surrounding area information acquisition system 3 specifies the surrounding area of the own vehicle A. For example, the surrounding area AR1 identified by the surrounding area information acquisition system 3 is shown as a hatched area in FIG. 2. In the surrounding area information acquisition system 3, the location of the vehicle A is acquired by the GNSS 3_1, and the information of the surrounding area AR1 is acquired based on the acquired location information and the map data registered in advance, and the like. That is, by referring to the acquired location information, the information of the surrounding area AR1 recorded in the map data is acquired. For example, in FIG. 2, information of the surrounding area AR1 includes a T-shaped intersection 10_T and the metal fence 12 that is installed facing the road 10_2 at the T-shaped intersection 10_T. The information of the surrounding area AR1 is stored in the area information storing unit 3_2. The information stored in the area information storage unit 3_2 is output as the surrounding area information 3DB.

As described above, the assistance system 4 may generate the assistance information 4DH based on the surrounding area information 3DB without using the monitoring detection information 2DB. First, the assistance information 4DH is generated based only on the surrounding area information 3DB.

In the situation shown in FIG. 3, as described above, since the bicycle B is outside the detection range of the radar 2_1, the surrounding monitoring system 2 cannot detect the bicycle B. In the situation shown in FIG. 4, the bicycle B moves forward and is within the detection range of the radar 2_1 of surrounding monitoring system 2. However, since the metal fence 12 having a large radar reflection cross-section area is installed in the front side of the radar 2_1, the dynamic range of the radar 2_1 is set so as to detect the metal fence 12 (as shown in FIG. 6). Therefore, the reflected wave from the bicycle B having a small radar reflection cross-section area as compared to the metal fence 12 falls below the minimum level (min) of the set dynamic range DRG, it is difficult for the radar 2_1 to detect the bicycle B.

The assistance system 4 recognizes, based on the surround area information 3DB, the T-shaped intersection 10_T and the metal fence 12. Then, the assistance system 4 outputs (notifications) the assistance information 4DH indicating that an object having a large radar reflection cross-sectional area, that is, an object having a large reflected wave, such as a metal fence, is installed within the radar detection range, to the surrounding monitoring system 2. For example, the assistance system 4 may output the assistance information 4DH based on the surrounding area information 3DB, when it is determined that the object generating a reflected wave of a predetermined intensity or more is included in the detection range of the radar 2_1.

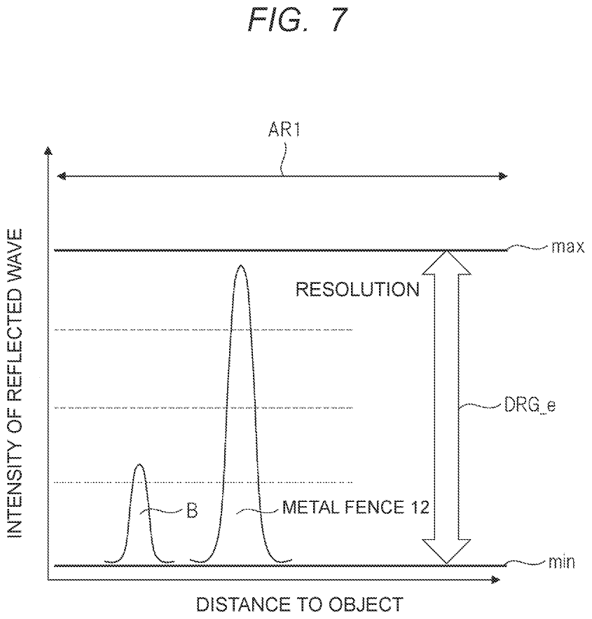

Upon receiving this notification, the surrounding monitoring system 2 controls the radar 2_1 so that it is possible to also detect objects having a small radar reflection cross-section area. In the first embodiment, as shown in FIG. 7, the surrounding monitoring system 2 controls the radar 2_1 so as to widen the dynamic range as the dynamic range DRG_e. That is, the assistance information 4DH is an instruction information to dynamically control the radar 2_1. This allows the surrounding monitoring system 2 to detect objects having small radar reflection cross-section area. As shown in FIG. 7, the reflected wave from the metal fence 12 and the reflected wave from the bicycle B are in the expanded dynamic range DRG_e, both of the presence of the metal fence 12 and the presence of the bicycle B are detected. Therefore, even if the vehicle moves into the viewable range of the own vehicle from outside of the viewable range, the surroundings monitoring system 2 detects the vehicle. As a result, the distance from the bicycle A to the bicycle B can also be obtained.

Thus, even if there is an object having a large radar reflection cross-sectional area within the detection range of the radar, for example, it is possible to detect a vehicle (bicycle) crossing the front, it is possible to smoothly avoid the collision.

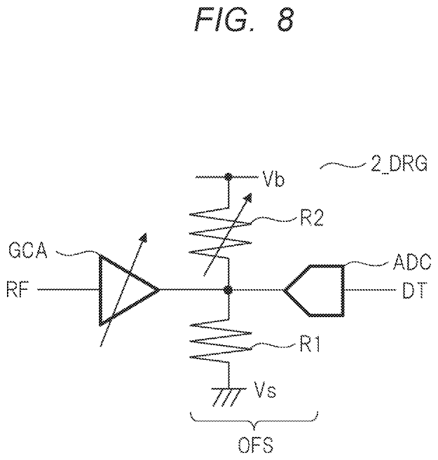

Next, an example of a configuration for controlling the dynamic range of the radar 2_1 will be described with reference to the drawings. FIG. 8 is a circuit diagram showing a configuration of a range control circuit according to the first embodiment. FIG. 8 shows the range control circuit 2_DRG provided in the surrounding monitoring system 2. The range control circuit 2_DRG includes a gain variable amplifier GCA, a DC offset adjuster OFS, and an analog-to-digital converter ADC. The reflected wave from the object is input as an analog signal RF to the gain variable amplifier GCA. The DC offset of the analog signal RF amplified by the gain variable amplifier GCA is adjusted by the DC offset adjuster OFS including the resistor R1 and the variable resistor R2 that are connected in series between the bias voltage Vb and the ground voltage Vs. Then, the analog signal RF is converted by the analog-to-digital converter ADC to the digital signal DT. The digital signal DT becomes a signal indicating the presence or the like of the object.

In the surrounding monitoring system 2, the gain variable amplifier GCA and the DC offset adjuster OFS is controlled by the assistance information 4DH. Briefly, the gain variable amplifier GCA adjusts the amplitude, and the DC offset adjuster OFS adjusts the DC offset, so that the dynamic range of the radar relative to the reflected wave is changed.

In FIG. 7, the dynamic range DRG is expanded to DRG_e by decreasing the resolution as compared with FIGS. 5 and 6, but the present invention is not limited thereto. For example, by changing the bit-width of the analog-to-digital converter ADC shown in FIG. 8 according to the assistance information 4DH, while maintaining the resolution with high accuracy, it is also possible to expand the dynamic range DRG.

As shown in FIG. 1, the assistance system 4 may generate the assistance information 4DH based on the monitoring detection information 2DB and the surrounding area information 3DB. In this case, the assistance system 4, for example, based on the monitoring detection information 2DB, detects the presence of the metal fence 12, and determines, based on the surrounding area information 3DB, that the own vehicle has entered the surrounding area AR1. The assistance system 4 generates the assistance information 4DH when both conditions are satisfied. The detection accuracy can be improved by the assistance information 4DH generated when both conditions are satisfied.

In FIG. 1, the case where the surroundings monitoring system 2 uses the radar 2_1 as a sensor has been described, but the present invention is not limited thereto. For example, a camera or the like may be used as a sensor.

According to the collision avoidance system 1 of the first embodiment, the surrounding monitoring system 2 is controlled in accordance with the information specific to the surrounding area detected by the surrounding area information acquisition system. As a result, it becomes possible to detect vehicles that need to avoid collisions in a short time, and it is possible to smoothly perform actions of collision avoidance.

### Second Embodiment

In the second embodiment, a collision avoidance system is provided in which the surrounding monitoring system comprises different types of sensors and uses sensors suitable for the detected surrounding area.

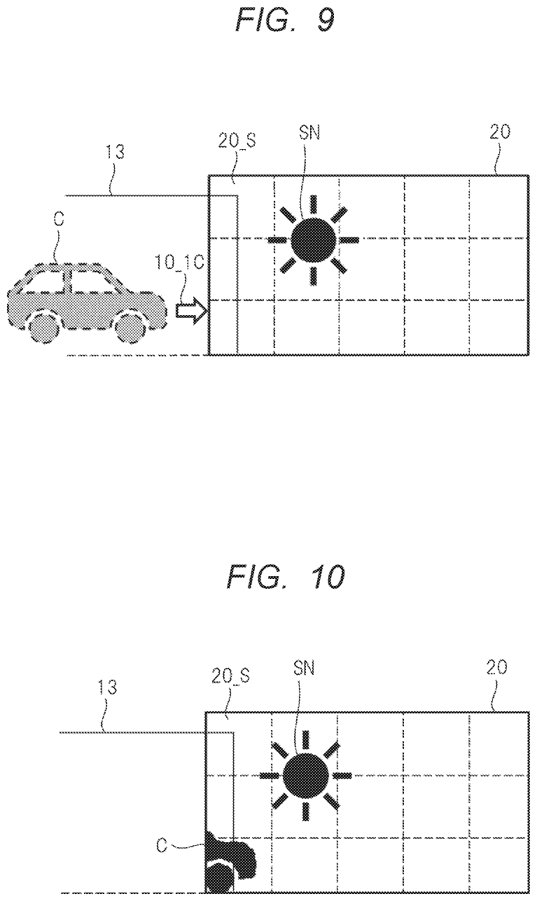

Before describing the details of the second embodiment, first, a problem to be solved in the second embodiment will be described with reference to the drawings. FIGS. 9 and 10 are diagrams for explaining the problem to be solved in the second embodiment. Here, the surrounding monitoring system provided in the collision avoidance system mounted on the own vehicle (not shown) will be described with reference to a case where a camera is used as a sensor.

In FIG. 9, reference numeral 13 denotes a building that installs along a road, and reference numeral C denotes a vehicle that exists behind the building 13 and is driven in the direction 10_1C when viewed from the own vehicle. In FIG. 9, reference numeral 20 denotes a detection range that can be detected by the camera of the surrounding monitoring system. In this case, the camera captures the detection range 20. The image of the detection range 20 obtained by capturing is divided into a plurality of processing unit ranges 20_S (5×3=15 in FIG. 9). The surrounding monitoring system performs image processing for detecting a moving object, such as a vehicle, and the like for each divided processing unit range 20_S. In FIG. 9, the sun SN is shown in the image of the detection range 20.

The vehicle C is hidden behind the building 13 and it is outside the detection range of the camera of the surrounding monitoring system. Therefore, the camera or the like of the surrounding monitoring system mounted on the own vehicle dose not detect the vehicle C. The vehicle C moves forward, as shown in FIG. 10, a part of the vehicle C appears from the building 13. It is possible to photograph the vehicle C by the camera. However, at this time, as shown in FIG. 10, the sunlight from the sun SN is included in the detection range 20. That is, a situation in which very strong light is incident on the camera. Therefore, the vehicle C is photographed in the situation of so-called backlight, so that the vehicle C is recognized as a shadow. Even in the situation of backlight, if the exposure or the like of the camera are adjusted, it is possible to detect the details of the vehicle C, such as the shape and speed including the vehicle type of the vehicle C. However, it may be difficult to detect the details of the vehicle C in a short time.

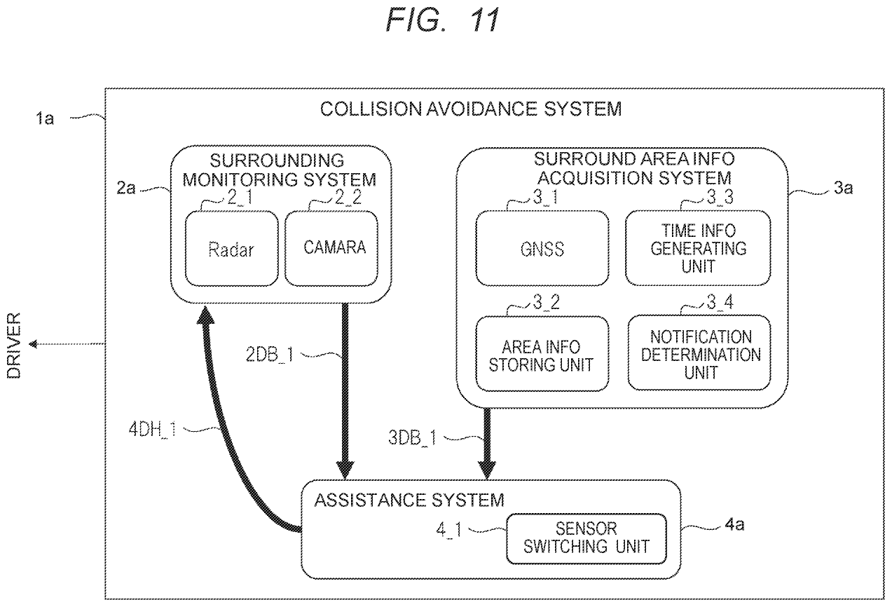

FIG. 11 is a block diagram showing a configuration of a collision avoidance system according to the second embodiment. FIG. 11 shows a collision avoidance system 1a. Since FIG. 11 is similar to FIG. 1, the main differences will be explained.

The surrounding monitoring system 2a shown in FIG. 11 is different from the surrounding monitoring system 2 of FIG. 1 in that it includes a plurality of sensors of different types from each other. That is, the surrounding monitoring system 2a of FIG. 11 includes a radar 2_1 and a camera 2_2 as sensors. The surroundings monitoring system 2a outputs vehicle information detected based on information detected by the radar 2_1 and/or information detected by the camera 2_2 as monitoring detection information 2DB_1.

The surrounding area information acquisition system 3a is different from the surrounding area information acquisition system 3 of FIG. 1 in that the surrounding area information acquisition system 3a further includes the time information generating unit 3_3 and the notification determination unit 3_4. The time information generation unit 3_3 includes, for example, a clock, and generates time information indicating the current time. The notification determination unit 34 generates the surrounding area information 3DB_1 based on the information of the location detected by the GNSS3_1, the unique information of the surrounding area acquired based on the map data, and the time information. That is, the surrounding area information 3DB_1 is time-dependent information.

The assistance system 4a differs from the assistance system 4 shown in FIG. 1 in that it further comprises a sensor switching unit 4_1. The assistance system 4a generates assistance information based on the surrounding area information in the same manner as in FIG. 1. The assistance information 4DH_1 according to the second embodiment is output from the assistance system 4a to the surrounding monitoring system 2a. The assistance information 4DH_1 includes sensor switching information generated by the sensor switching unit 4_1 based on the surrounding area information 3DB_1. The sensor switching information is information for switching a plurality of sensors (radar 2_1 and camera 2_2) included in the surrounding monitoring system 2a. The surrounding monitoring system 2a is controlled based on the assistance information 4DH_1. In addition, the surrounding monitoring system 2a selects information obtained from a sensor suitable for the surrounding area among information obtained from a plurality of sensors based on the assistance information 4DH_1. The surrounding monitoring system 2a generates the monitoring detection information 2DB_1 based on information from the selected sensors.

### <Operation of the Collision Avoidance System>

### Operation Example 1

In the surrounding area information acquisition system, unique information of the surrounding area of the own vehicle is generated based on the GNSS3_1 and the map data. In this case, information such as whether or not the moving direction of the own vehicle, that is, the sensor of the surrounding monitoring system 2a is directed in the direction of the sun SN, is generated as unique information of the surrounding area. At this time, the position of the sun SN in the sky is obtained by the time information generated by the time information generating unit 3_3. The notification determination unit 3_4 specifies whether or not the sun SN appears within the detection range 20 of the camera 2_2. The notification determination unit 3_4 further specifies the position (detection range) of the sun SN within the detection range 20 based on the time information and unique information of the surrounding area, and outputs the specified information as the surrounding area information 3DB_1.

Based on the surrounding area information 3DB_1, the sensor switching unit 4_1 in the assistance system 4a generates sensor switching information for switching the sensors, and outputs the assistance information 4DH_1 including the sensor switching information to the surrounding monitoring system 2a. The surrounding monitoring system 2a, based on the sensor switching information, performs signal processing of the signal obtained from the sensor.

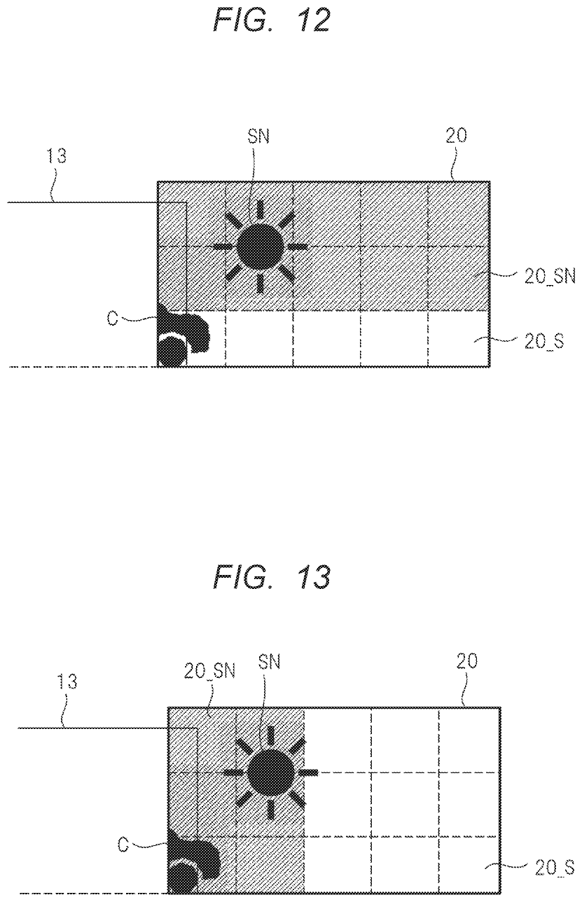

FIGS. 12 and 13 are diagrams for explaining an operation example 1 of the collision avoidance system according to the second embodiment. For example, in FIGS. 12 and 13, it is assumed that the surrounding area information 3DB_1 indicates that the sun SN is photographed in the detection range 20_SN filled with hatching pattern. Based on the surrounding area information 3DB_1, the sensor switching unit 4_1 notifies the surrounding monitoring system 2a of the assistance information 4DH_1. The detection range 20_SN is detected by using the radar 2_1 and the detection range other than the detection range 20_SN, which is not filled with hatching pattern, is detected by using the camera 2_2. In accordance with this notification, the surrounding monitoring system 2a performs object detection processing on the detection range 20_SN based on the information obtained by the radar 2_1, and performs object detection processing (image processing) on the detection range other than the detection range 20_SN based on the information (video) obtained by the camera 2_2. That is, the surrounding monitoring system 2 switches the sensor information to be subjected to the object detection processing in each processing unit range based on the surrounding area information 3DB_1. In this manner, the surrounding monitoring system 2a generates the monitoring detection information 2DB_1 based on the information obtained from the plurality of sensors. As a result, the vehicle C can be detected using not only by using the information detected by the camera 2_2 but also the information detected by the radar 2_1, and smooth collision avoidance can be performed.

Alternatively, when the surrounding area information 3DB_1 indicates that the sun SN appears on the detection range 20, the sensor switching unit 4_1 may instruct the surrounding monitoring system 2a to detect on the entire area of the detection range 20 by using the radar 2_1 in place of the camera 2_2. In this case, detection by the camera 2_2 may be stopped. In addition, until the exposure of the camera 2_2 is adjusted, the detection by the radar 21 may be performed. After the adjustment of the exposure is completed, the sensor may be switched so as to use the camera 2_2.

### Operation Example 2

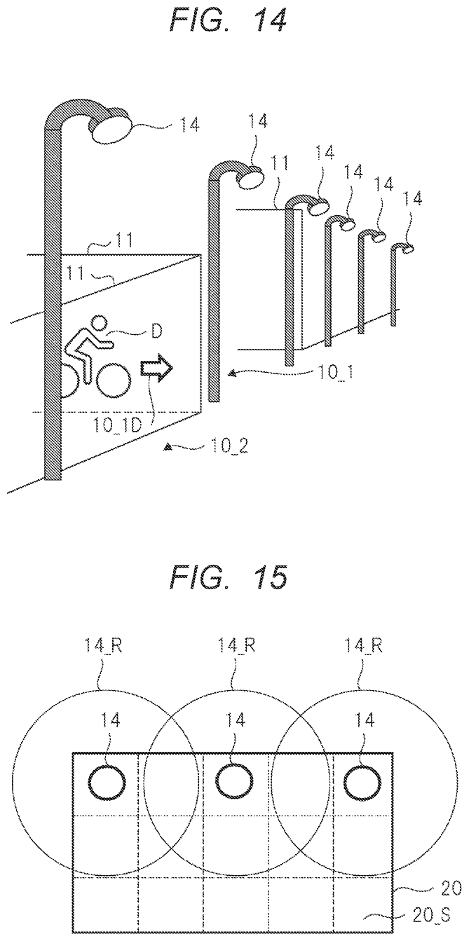

FIG. 14 to FIG. 18 is a diagram for explaining an operation example 2 of the collision avoidance system according to the second embodiment.

In FIG. 14, reference numeral 14 denotes a streetlight installed on the road 10_2. FIG. 14 shows a situation in which the bicycle D, which is a vehicle, enters toward the intersection of the road 10_1 and the road 10_2 (in direction 10_1D). Further, FIG. 14 is a situation at night, streetlights 14 are on, and although not shown, the own vehicle is moving toward the intersection on the road 10_2.

The own vehicle includes the collision avoidance system 1a shown in FIG. 11, and it is necessary to avoid a collision with the bicycle D. However, in the situation shown in FIG. 14, the bicycle D is difficult to detect by the radar 2_1 and the camera 2_2 because it is hidden by the wall 11, i.e. it is outside the detection range of the surrounding monitoring system 2a.

The detection range 20 of the camera 2_2 at this time is shown in FIG. 15. In FIG. 15, reference numeral 14_R indicates an area lightened by the streetlight 14. The image captured by the camera 2_2 includes bright areas 14_R and an area outside the area 14_R where the lights of the streetlights 14 do not reach and darkens. The image thus captured is processed and detected for each processing unit range 20_S.

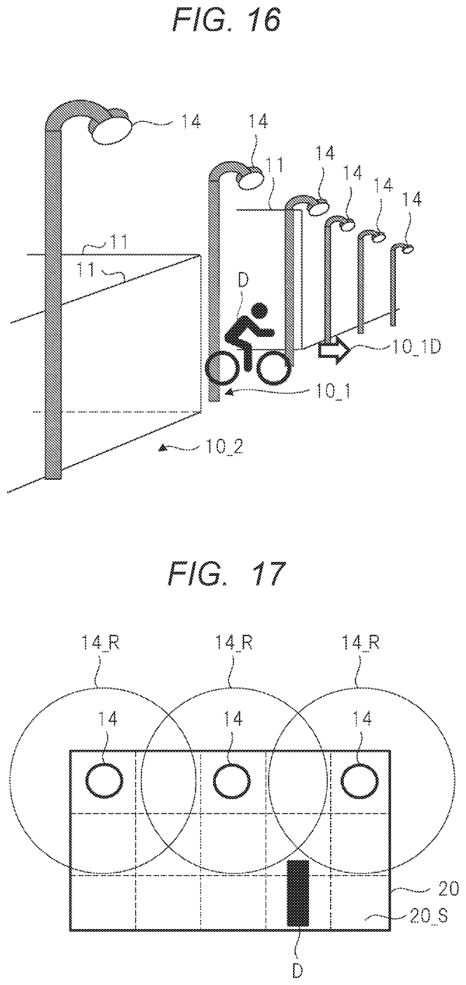

The situation in which the bicycle D has progressed and entered the intersection is shown in FIG. 16. The detection range 20 of the camera 2_2 at this time is shown in FIG. 17. The bicycle D enters the intersection and move into the detection range 20 of camera 2_2. As shown in FIG. 17, the bicycle D appears between bright areas 14_R that are brightened by streetlights 14. That is, since the bicycle D appears in an area which is not lighted by the streetlights 14, it is difficult to detect the bicycle D based on information from the camera 2_2 in a short time.

In the surrounding area information acquisition system 3a according to the second embodiment, based on the GNSS3_1 and the map data, unique information of the surrounding area including information specifying the streetlights 14 is generated. Further, it is specified that the time is at night by the time information generated by the time information generating unit 3_3. When it is specified that the night, the notification determination unit 3_4 identifies an area to be brightened by the streetlights 14 and a dark area based on the information identifying the streetlight 14. The surrounding area information acquisition system 3a outputs the surrounding area information 3DB_1 including information for specifying a bright area and a dark area. The assistance system 4a generates sensor switching information based on information identifying bright area and dark area. Based on the sensor switching information, the surrounding monitoring system 2a switches which of the information detected by the radar 2_1 and the information detected by the camera 2_2 is used for each processing unit range.

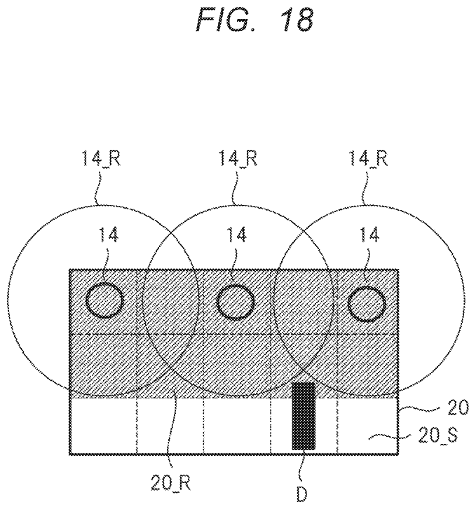

In FIG. 18, the area 20_R filled with hatching pattern is a portion shown as a bright area by the sensor switching information. The area other than the area 20_R in the detection range 20 is a portion shown as a dark area by the sensor switching information. In the surrounding monitoring system 2a, the detection operations on the area 20_R are performed by using the information (video image) detected by the camera 2_2, the detection operations of the area other than the area 20_R is performed by using the information detected by the radar 2_1.

In the second embodiment, as in the first embodiment, the assistance system 4a may generate the assistance information 4DH_1 based on the monitoring detection information 2DB_1 and the surrounding area information 3DB_1. In this case, the assistance system 4a detects backlight by, for example, the monitoring detection information 2DB_1, and determines sensor switching by the surrounding area information 3DB_1. The assistance system 4a generates the assistance information 4DH_1 when both conditions are met. Since the assistance information 4DH_1 generated when both conditions are met is used, it is possible to improve the accuracy.

According to the second embodiment, the sensors for detecting the object are switched on the basis of the information specific to the surrounding area. Switching sensors makes it possible to detect objects that need to avoid collisions in a short time, making it possible to smoothly perform actions for collision avoidance.

### Third Embodiment

In the third embodiment, in order to detect a vehicle that is present outside the detection range of the surrounding monitoring system, a collision avoidance system is provided with an approaching vehicle notification system for performing inter-vehicle communication with the vehicle that is present outside the detection range of the surrounding monitoring system. The collision avoidance system also includes an assistance system with a communication environment determination unit that determines the environment of inter-vehicle communication and outputs assistance information that controls the approaching vehicle notification system.

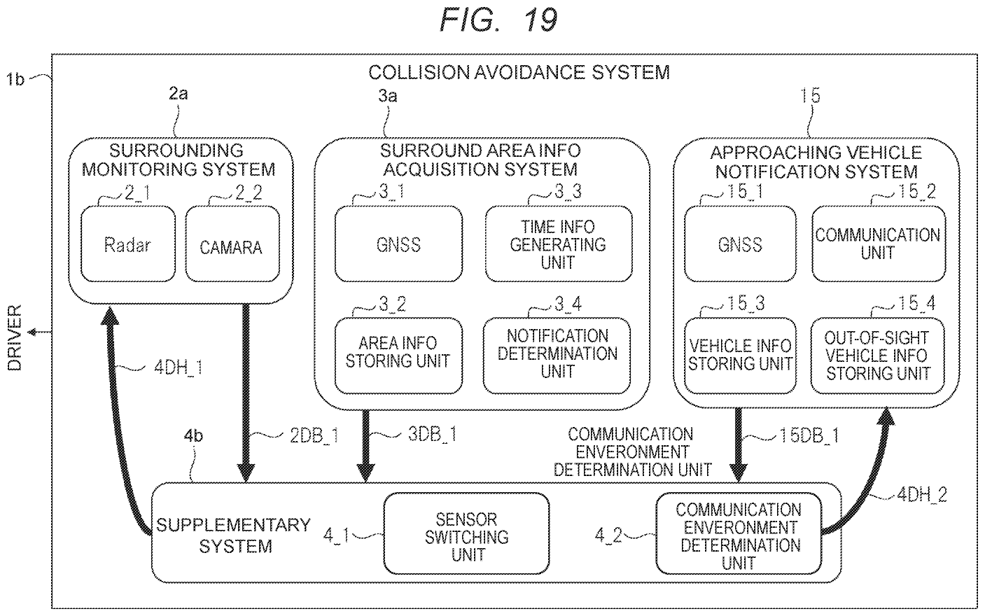

FIG. 19 is a block diagram showing a configuration of a collision avoidance system according to the third embodiment.

Since FIG. 19 is similar to FIG. 11, the differences will be mainly explained. The difference is that the collision avoidance system 1b of FIG. 19 further comprises an approaching vehicle notification system 15, and the assistance system 4b further comprises a communication environment determination unit 4_2. In the collision avoidance system 1b according to the third embodiment, functions achieved by the approaching vehicle notification system 15 and the communication environment determination unit 4_2 are added in addition to the functions of the collision avoidance system described in the second embodiment. Incidentally, the assistance system 4b shown in FIG. 19, to assist both the surrounding monitoring system 2b and the approaching vehicle notification system 15, can be regarded as an assistance system for the surrounding monitoring system and the approaching vehicle notification system.

The approaching vehicle notification system 15 includes a plurality of units. However, in FIG. 19, only those necessary for description is shown. That is, the approaching vehicle notification system 15 includes a GNSS 15_1, a communication unit 15_2, a vehicle information storing unit 15_3, and an out-of-sight vehicle information storing unit 15_4.

Like the GNSS 3_1 of the surrounding area information acquisition system, the GNSS 15_1 detects the location or the like of the own vehicle on which the collision avoidance system 1 is mounted. Therefore, one GNSS may be used for both GNSS 15_1 and GNSS 3_1. The communication unit 15_2 is a communication device for performing communication (inter-vehicle communication) between the own vehicle and other vehicle (e.g., a vehicle approaching the own vehicle). The vehicle information storing unit 15_3 stores information on the vehicle, such as the vehicle type. The out-of-sight vehicle information storing unit 15_4 stores the information of the approaching vehicle received by the inter-vehicle communication.

The approaching vehicle notification system 15 performs inter-vehicle communication with the approaching vehicle to detect the approaching vehicle, and outputs information of the detected approaching vehicle as the approaching detection information 15DB_1 to the assistance system 4b. Further, the approaching vehicle notification system 15, through inter-vehicle communication, transmits the information of the own vehicle and the location of the own vehicle detected by GNSS 15_1 to the approaching vehicle.

As described in the second embodiment, the assistance system 4b generates the assistance information 4DH_1 that controls the surrounding monitoring system 2a based on the surrounding area information 3DB_1 from the surrounding area information acquisition system 3a. At this time, the sensor switching unit 4_1, as described above, generates a sensor switching information for switching between the sensors in the surrounding monitoring system 2a. With the surrounding area information 3DB_1, the sensors in the surrounding monitoring system 2a are switched so as to be suitable for the information specific to the surrounding area.

Further, the communication environment determination unit 4_2 in the assistance system 4b, based on the surrounding area information 3DB_1, generates the assistance information 4DH_2 corresponding to the specific information of the surrounding area indicated by the surrounding area information 3DB_1, and outputs the assistance information to the approaching vehicle notification system 15. The assistance information 4DH_2 may be referred to as second assistance information. The communication unit 15_2 of the approaching vehicle notification system 15 is controlled by the assistance information 4DH_2. For example, the communication interval, modulation method, transmission power, and the like of the inter-vehicle communication performed by the communication unit 15_2 are changed based on the assistance information 4DH_2.

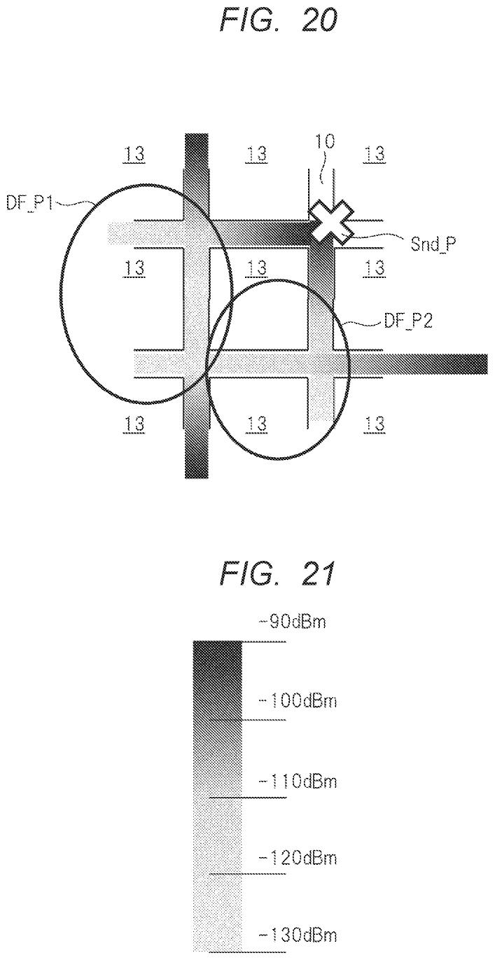

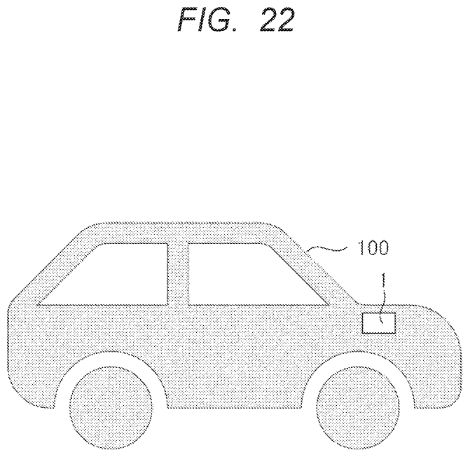

FIGS. 20 and 21 are diagrams for explaining a collision avoidance system according to the third embodiment. Here, FIG. 20 is a schematic plan view of the surrounding area. In other words, the situation when the surrounding area is viewed from the sky is shown in FIG. 20. In FIG. 20, reference numeral 10 denotes a road, and reference numeral 13 denotes a building constructed along the road 10. Further, in FIG. 20, the reception power of the radio wave received on the road 10 is indicated by the shading pattern, when the radio wave is emitted at the position Snd_P. FIG. 21 shows the correspondence between the shade patterns shown in FIG. 20 and the value of the received power. As shown in FIG. 21, the darker the shading pattern, the greater the received power.

The received power of the radio waves used in the vehicle-to-vehicle communication is affected by the building 13 and the multipath, as shown in FIG. 20, and varies depending on the position. For example, in certain communication intervals or specific modulation method, the inter-vehicle communication is possible with vehicles located at a position of −110 dBm or more of the received power, and may not be possible with vehicles at a position of lower received power than this. In FIG. 20, the specific areas in which the received power is lower than −110 dBm are denoted by the reference numerals DF_P1 and DF_P2. In this case, when the own vehicle A is located at the position Snd_P, it is difficult to perform inter-vehicle communication with the vehicles located in the specific areas DF_P1 and DF_P2. That is, communications with the vehicles located in the specific area DF_P1, DF_P2 are not established.

In the third embodiment, information unique to the surrounding area is provided to the communication environment determination unit 4_2 by the surrounding area information 3DB_1. The communication environment determination unit 4_2 determines whether or not the specific areas DF_P1 and DF_P2 as shown in FIG. 20 exist based on the unique information of the surrounding area. When it is determined that the specific areas DF_P1 and DF_P2 exist in the surrounding area, the communication environment determination unit 4_2 instructs the communication unit 15_2 to change the communication interval, modulation method, transmission output, and/or the like of the inter-vehicle communication based on the assistance information 4DB_2.

By this instruction, the communication unit 15_2 shortens the communication interval, increases the demodulation gain by changing the modulation method, and increases the transmission output. This modification enables inter-vehicle communication with the vehicles located in the specific areas DF_P1 and DF_P2.

That is, the communication environment is improved.

The communication environment determination unit 42 may generate the assistance information 4DB_2 not only based on the surrounding area information 3DB_1 but also based on both of the approaching detection information 15DB_1 and the surrounding area information 3DB_1. For example, when the communication environment determination unit 4_2 determines that the specific areas DF_P1 and DF_P2 based on the surrounding area information 3DB_1 and determines that the communication with the vehicle located in the specific areas DF_P1 and DF_P2 has not been performed by using the approaching detection information 15DB_1, the assistance information 4DH_2 for changing the communication interval, the modulation method, and/or the transmission output may be generated. By using the assistance information 4DH_2, it is possible to improve the accuracy. Depending on the communication environment, the communication interval, the modulation scheme and/or the transmission output or the like is changed. When the communication environment is good, for example, it is possible to increase the communication interval and to lower the transmission power. As a result, it is possible to reduce the power consumption of the collision avoidance system 1.

According to the third embodiment, it is possible to further improve the communication environment and improve the detection of out-of-sight vehicles, as compared with the collision avoidance system according to the second embodiment.

Although the invention made by the present inventor has been specifically described based on the embodiment, the present invention is not limited to the embodiment described above, and it is needless to say that various modifications can be made without departing from the gist thereof.

What is claimed is:

1. A collision avoidance system, comprising:
a surrounding monitoring system having a sensor unit and configured to generate a monitoring detection information based on a sensor information output from the sensor unit;
a surrounding area information acquisition system configured to acquire a surrounding area information associated with a current location; and
an assistance system configured to receive the surrounding area information and generate an assistance information based on the surrounding area information to control the surrounding monitoring system.

2. The collision avoidance system according to claim 1,
wherein the assistance system is configured to generate the assistance information based on the monitoring detection information in addition to the surrounding area information.

3. The collision avoidance system according to claim 1,
wherein the sensor unit comprises at least one of camera and a radar.

4. The collision avoidance system according to claim 1,
wherein the surrounding monitoring system is configured to change a dynamic range of the sensor unit based on the assistance information.

5. The collision avoidance system according to claim 1,
wherein the sensor unit includes a plurality of sensors, each of sensors outputting a sensor information and
wherein the assistance information includes a switch information indicating which sensor information to be used in order to generate the monitoring detection information.

6. The collision avoidance system according to claim 5,
wherein the surrounding monitoring system is configured to divide a detection range of the sensor unit into a plurality of processing unit ranges and perform an object detection processing for each processing unit ranges by using the sensor information specified based on the assistance information.

7. The collision avoidance system according to claim 5,
wherein the surrounding area information acquisition system includes a time information generating unit generating a time information, and
wherein the assistance system configured to generate the assistance information based on the surrounding area information and the time information.

8. The collision avoidance system according to claim 7,
wherein the assistance system is configured to generate the assistance information based on the surrounding area information and the monitoring detection information.

9. The collision avoidance system according to claim 1, further comprising:
an approaching vehicle notification system configured to perform inter-vehicle communication with an approaching vehicle,
wherein the assistance information is a first assistance information, and
wherein the assistance system is configured to generate a second assistance information based on the surrounding area information to control the approaching vehicle notification system.

10. The collision avoidance system according to claim 9,
wherein the assistance system is configured to generates the second assistance information based on the surrounding area information and approaching detection information from the approaching vehicle notification system.

11. A vehicle comprising:
a sensor; and
a collision avoidance system comprising:
a surrounding monitoring system configured to perform an object detection processing based on a sensor information from the sensor and generate a monitoring detection based on a result of the object detection processing;
a surrounding area information acquisition system configured to identify a current location of the vehicle and output a surrounding area information of the vehicle based on the identified current location; and
an assistance system configured to receive the surrounding area information and generate an assistance information based on the surrounding area information to control the surrounding monitoring system;
wherein the collision avoidance system is configured to notify an approaching vehicle information to a driver of the vehicle based on the result of the object detection processing.

12. The vehicle according to claim 11,
wherein the assistance system configured to generate the assistance information based on the surrounding area information and the monitoring detection information.

13. The vehicle according to claim 12,
wherein the sensor includes a camera and a radar.

14. The vehicle according to claim 11,
wherein the sensor incudes a camera and a radar,
wherein the assistance system is configured to generate the assistance information including sensor switching information for switching between the camera and the radar.

15. The vehicle according to claim 11,
wherein the collision avoidance system further includes an approaching vehicle notification system configured to perform inter-vehicle communication with an approaching vehicle,
wherein the assistance information is a first assistance information, and
wherein the assistance system is configured to generate a second assistance information based on the surrounding area information to control the approaching vehicle notification system.

16. The vehicle according to claim 16,
wherein the assistance system is configured to generates the second assistance information based on the surrounding area information and approaching detection information from the approaching vehicle notification system.
